(19) United States
(12) Patent Application Publication
(10) Pub. No.: US 2015/0314564 A1
(43) Pub. Date: Nov. 5, 2015

(54) LAMINATED MAGNESIUM CEMENT WOOD FIBER CONSTRUCTION MATERIALS

(71) Applicant: CHICAGO FLAMEPROOF & WOOD SPECIALTIES CORP., Montgomery, IL (US)

(72) Inventors: Vincent MANCINI, Downers Grove, IL (US); Futong CUI, Charlotte, NC (US)

(21) Appl. No.: 14/704,509

(22) Filed: May 5, 2015

Related U.S. Application Data
(60) Provisional application No. 61/988,663, filed on May 5, 2014.

(51) Int. Cl. B32B 13/10

(52) U.S. Cl. CPC B32B 13/10; B32B 2419/04

(57) ABSTRACT

A Laminated Magnesium Cement (MgO) Wood Fiber Construction Board utilizes structural plywood, OSB, fiber board, or other suitable flammable building materials with a lamination of MgO board laminated to the structural substrate using an adhesive having suitable properties, manufactured in a method including but not limited to a setup/transport station, adhesive to MgO board application, lay-up, transport, compression, curing and packaging steps, whereby flame spread and smoke development for the finished structural construction board exceeds prior art testing procedures.

### BACKGROUND OF THE INVENTION

A widely accepted test method for flame retardant treated wood is the ASTM E-84 developed by the American Society for Testing and Materials. Building materials meeting the Class A ASTM E-84 standard have a flame spread index greater than zero (0) but less than 25. It is well known that inorganic materials such as Portland cement and magnesium cement are non-combustible. The composite building material disclosed in this invention meets the Class A ASTM E-84 standard. The composite building material also has improved strength properties.

Existing practices in Class A ASTM E-84 fire retardant treated wood products such as plywood or lumber are to infuse the wood fiber material with an aqueous solution of a water soluble flame retardant formulation such as phosphates and/or borates. This infusion is typically performed under vacuum pressure, which requires a subsequent drying step after the infusion process. The subsequent drying step involves removing water from the product, such as by kiln drying, to return the product to its original moisture content.

The infusion process has drawbacks. First, wood based products tend to check and warp due to changes in moisture content during the treating and drying processes. In some cases, warped materials may cause problems to the end user. In other cases, excessively warped materials may have to be discarded at the construction job site.

Second, because most flame retardants are acidic, the infusion and subsequent drying process tends to reduce the strength of wood based products. This occurs when the water absorbed by the treated wood reacts chemically with the fire retardant to produce a condition known as hydrolysis. Hydrolysis, which is especially damaging under high temperature and high humidity conditions, attacks the fiber of the wood causing it to become brittle and lose strength. Some flame retardants decompose at high temperatures, a process which increases their acidity and leads to accelerated wood polymer hydrolysis.

Third, the effectiveness of the infusion process may be reduced if the treated wood is subsequently exposed to water. For example, if the treated wood is exposed to moisture such as rain during transport or on the job site, such exposure could lead to leaching of the fire retardant because the chemicals are water soluble.

The current invention provides a Class A ASTM E-84 fire retardant treated wood product without these drawbacks.

### DESCRIPTION OF RELATED ART

Magnesium based cementitious materials are well known. Magnesia (magnesium oxide) is known for its excellent fire resistance and is widely used in refractory materials. The same applies for magnesium oxychloride cement (MOC), also known as Sorel cement, which was invented in the 19th century. Other types of well known cementitious materials include magnesium oxysulfate cement (MOS) and magnesium phosphate cement (MAP). When made into sheets or boards as construction materials, these cementitious materials are known on the market place as MgO board or simply MgO. MgO boards are widely available around the world.

Some MgO board manufacturers claim to use proprietary formulations and processes for special performance. Patents such as U.S. Pat. No. 7,255,907, U.S. Pat. No. 7,746,688, U.S. Pat. No. 7,998,547, and U.S. Pat. No. 8,066,812 are exemplary of such processes. Most MgO boards have excellent fire resistance and are useful as the laminate material for this invention.

U.S. Pat. No. 7,740,700 and U.S. Pat. No. 8,182,605 are directed to decorative surface coatings for foundation materials which incorporate a cementitious veneer. They disclose a preferred foundation material that is stiff and non-breathable. Hexcomb™ structural cardboard made by Pactiv Corporation is used as an example. In these patents, the cementitious layers were formed on the foundation material by applying a polyvinyl alcohol (PVA) primer and then spraying or manually spreading the cementitious layer on the foundation material. The cementitious laminate composition described by the patents have sufficient strength to resist chipping and cracking, but are not claimed to be fire resistant. In any event, the polyvinyl alcohol primer likely has a melting point of around 200° C. or lower and would fail in the case of a fire.

### SUMMARY OF THE INVENTION

A flame resistant laminate composition, and method of manufacturing the composition are provided. The laminate composition includes a building material such as plywood or oriented strand board (OSB), an adhesive, and a solid, prefabricated cementitious material such as MgO board. The MgO board is pre-manufactured and typically 3 mm to 4 mm in thickness, although various thicknesses can be used. The adhesive is typically applied to the cementitious material to provide an adhesive surface that bonds the building material to the cementitious material. The bond between the building material and cementitious material is allowed to cure under pressure. Adhesive lamination is preferred. However, the building material may be attached to the cementitious material using nails, screws, staples, or other suitable fasteners.

The laminate composition provides a Class A ASTM E-84 fire retardant treated wood product that is dimensionally stable and higher in structural strength as compared to the original building material.

Other features and advantages of the present invention will be apparent from the accompanying drawings and from the detailed description that follows below.

### BRIEF DESCRIPTION OF THE DRAWINGS

FIG. 1 is a perspective view of the flame resistant laminate composition.

FIG. 2 is flow chart illustrating one method for producing construction boards of the invention.

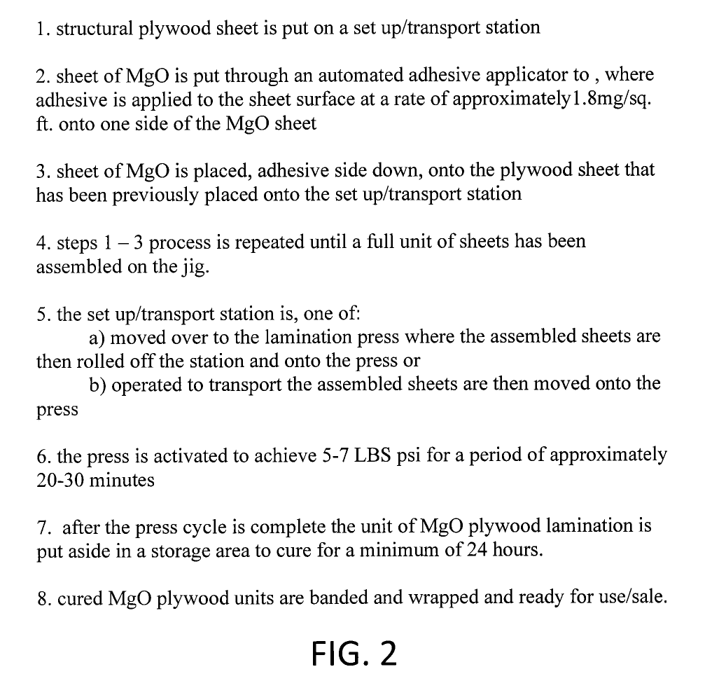

FIG. 3 represents a single lap design of laminated products.

FIG. 4 represents a double lap design of laminated products.

FIG. 5 illustrates a layout and adhesive application pattern for laminating large sheets and cutting them into multiple lap strips.

FIG. 6 illustrates an I-joist.

FIG. 7 illustrates the lamination of MgO boards to engineered wood products such as I-joists. MgO board is slightly smaller than the OSB web to leave a space between the OSB web and the 2×3 flange. A bead of flexible fire retardant caulking is applied around the edges of the OSB web to seal the gap between the MgO board and the flanges.

### DETAILED DESCRIPTION

Embodiments of the present invention provide a flame resistant laminate composition and method of manufacturing the same. The laminate composition provides a Class A ASTM E-84 fire retardant treated wood product that is dimensionally stable and higher in structural strength as compared to the original building material. The laminate composition can be used as almost any type of building product. This includes, but is not limited to applications such as doors, siding, roof tiles, shingles, decking boards, and I-joists. The laminate composition can also be used to construct structures such as cabinets and furniture. The laminate composition may also include laps when required by the application.

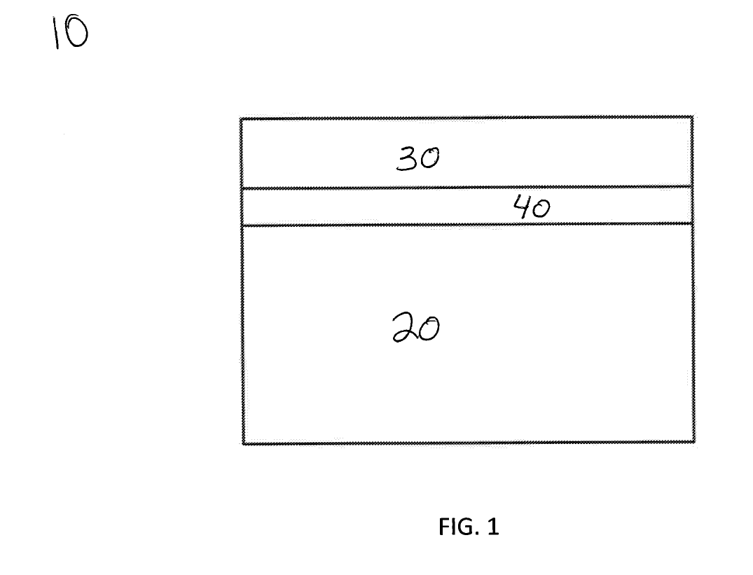

In the preferred embodiment as shown in FIG. 1, the laminate composition 10 described herein comprises a building material 20, a cementitious material 30, and an adhesive 40 applied to the cementitious material 30 to bond the building material 20 with the cementitious material 30. Any adhesive 40 that can maintain the structural integrity of the laminate composition 10 under normal service and fire conditions may be used.

The building material 20 is a substrate made from untreated or chemically treated structural plywood, OSB, fiber board, or other suitable building material. The building material 20 may be treated with preservatives, fire retardants, water repellents, insecticides, moldicides, or any combination thereof.

Commercially available building materials range in thickness, but are typically sold in ⅜″, ½″, ⅝″, ¾″ and 1″ thicknesses. These building materials also range in size with the primary sheet configuration being 4′×8′. Other typical commercially available sizes are 4′×9′ and 4′×10′. For the manufacture of fire resistant siding, roofing materials, shingles and decking materials, the wood and fiber substrate may be selected from solid wood, wood composites, or engineered wood products including but not limited to plywood, OSB, fiber board, laminated veneer lumber, and other similar types of structural building products.

In the preferred embodiment, the MgO board 30 is pre-manufactured and typically 3 mm to 4 mm in thickness. However, various thicknesses can be used in the 0.1 mm to 50 mm range. Commercially available MgO sheets 30 are typically sold in the in 4′×8′ configuration. These sheets 30 provide the exterior, fire retardant surface of the laminate composition 10.

The MgO board 30 may contain various property enhancing additives and/or colorants. For instance, the additives may be water repellents, synthetic or natural resins, fillers, biocides, or other property enhancing ingredients. The MgO board 30 may also have a laminate layer of plastic, metal, or composite materials for water resistance, weather resistance, or decorative purposes.

In the preferred embodiment, the bonding material 40 is a curable thermoset, thermoplastic, or ambient cured and cross-linked adhesive having a sufficiently high glass transition temperature (Tg) to retain its properties under fire exposure conditions. Exemplar high temperature resistant adhesives 40 are epoxy, silicone, or urethane adhesives. Inorganic adhesives 40 such as MgO are also extremely fire resistant. For critical applications such as structures with high fuel content, chemical plants, high voltage electrical cables high temperature epoxy resins, silicones and urethanes may be used. The adhesive 40 may be cured or cross-linked at ambient temperature.

A preferred adhesive 40 is a moisture cured polyurethane applied at a rate of 8-20 grams per square foot, although this value is not critical for the present invention. Any suitable application rate that can maintain the structural integrity of the laminate 10 under normal service and fire conditions may be used.

Another preferred adhesive 40 is an inorganic material such as uncured magnesia cement based on magnesia oxychloride, magnesia oxysulfate, or magnesia phosphate in the presence of various additives. The composition of these magnesia cement adhesives may have the same or different formulation as the pre-fabricated MgO boards 30. When applied, the inorganic adhesive 40 is applied at a thickness of approximately 0.1-1.0 mm. The advantages of inorganic adhesives 40 are the high temperature resistance and non-combustibility.

The bond between the building material 20 and cementitious material 30 is allowed to cure under pressure. Lamination with an adhesive 40 is preferred due to improved structural as well as fire performance integrity. However, the building material 20 may be attached to the cementitious material 30 using nails, screws, staples, or other suitable fasteners.

In the preferred method of manufacture, a building material board 20 is placed onto a mobile jig fixture. Next, an MgO board is fed through an automated adhesive 40 applicator, where adhesive 40 is applied to the board surface at a suitable rate onto one side of the MgO board 30. The MgO board 30 is then placed, adhesive side down, onto the building material sheet 20 which rests on the jig fixture. This process is repeated until a full unit of sheets has been assembled on the jig.

After transport to a press, the unit of sheets is ready for lamination. The lamination and adhesive curing process may be carried out using one sheet or several sheets at a time. The press is activated to achieve a load range of 1 to 20 pounds per square inch, and preferably 5 to 7 pounds per square inch for a period of approximately 20 to 30 minutes, or according to instructions and specifications of the adhesive manufacturer. After the press cycle is complete, the laminate composition 10 is allowed to cure for a minimum of 24 hours, or according to instructions and specifications of the adhesive manufacturer. Microwave heating, conventional heating, and other suitable techniques may be applied to accelerate adhesive curing and shorten the time the laminates 10 have to be kept under pressure. After the curing process is complete, the laminate composite material 10 is ready for use or subsequent manufacturing or processing. For instance, laminate composite material products for end use may be cut and manufactured from laminate composite 10 material sheets.

In some instances, subsequent operations may be performed on the MgO board 30 portion of the laminate composite material 10. To improve resistance to moisture, mold, algae, dirt, and other types of contamination, suitable additives may be applied to the MgO board portion of the finished laminate composite material 10. Water repellents, sulfates, phosphates, and silicates maybe added during the board manufacturing process to improve water resistance. Biocides and light sensitive pigments such as TiO₂ may be added to the MgO board portion 30 of the laminate composite material 10 to provide resistance to mold, algae, and dirt. To improve the visual appearance of the laminate composite material 10 for applications such as roofing, siding, and decking, the MgO board 30 may be stained, painted, or textured. Layers of plastic, metal, or composite materials may also be laminated to the MgO board 30 to further enhance performance or aesthetic properties. These subsequent operations may also be performed on the MgO board 30 before the lamination process.

The laminated composition 10 of the present invention has significantly improved mechanical properties as compared to the building material 20 alone.

TABLE 1

| | Load (lbs) | Deflection (″) | Deflection/load ratio |
|---|---|---|---|
| 7/16″ × 4′ × 8′ OSB | 1176 | 0.25 | 0.000213 |
| | 2279 | Fail | — |
| ⅝″ × 4′ × 8′ OSB | 1176 | 0.11 | 0.000094 |
| | 2279 | 0.235 | 0.000103 |
| | 2720 | 0.391 | 0.000144 |
| 7/16″ × 4′ × 8′ OSB | 2720 | 0.284 | 0.000104 |
| with 3/16″ MgO | | | |
| lamination | | | |
| ¾″ × 4′ × 8′ | 2720 | 0.329 | 0.000121 |
| plywood | | | |
| ⅝″ × 4′ × 8′ | 2720 | 0.21 | 0.000077 |
| plywood with | | | |
| 3/16″ MgO | | | |
| lamination | | | |

As shown in Table 1, the strength of 7/16″ OSB laminated with 3/16″ MgO far exceeds that of the 7/16″ OSB substrate and is similar or higher than the strength of ⅝″ OSB. Similarly, ⅝″ plywood laminated with 3/16″ MgO exceeds the strength of ¾″ plywood.

The laminated composition 10 of the present invention also has significantly improved flame retardant capabilities. In the preferred embodiment, the resulting laminate composition 10 has zero (0) flame spread and smoke development when tested according to the Class A ASTM E-84 fire retardant treated wood specification. However, flame spread and smoke development values greater than zero (0) are permitted to the extent that the laminate composition falls within the Class A ASTM E-84 fire retardant treated wood range designations.

Table 2 illustrates selected properties of a preferred embodiment of a laminated plywood composition 10.

TABLE 2

| | |
|---|---|
| Time to Ignition (sec): | 552 |
| Time to Max FS (sec): | 0 |
| Maximum FS (feet): | 0.0 |
| Time to 980 F. (sec): | Never Reached |
| Time to End of Tunnel (sec): | Never Reached |
| Max Temperature (F.): | 552 |
| Time to Max Temperature (sec): | 600 |
| Total Fuel Burned (cubic feet): | 43.71 |
| FS*Time Area (ft*min): | 0.0 |
| Smoke Area (% A*min): | 0.9 |
| Unrounded FSI: | 0.0 |

The laminated composition 10 of this embodiment meets the Class A ASTM E-84 standard as illustrated in Table 3 and therefore has excellent fire performance properties.

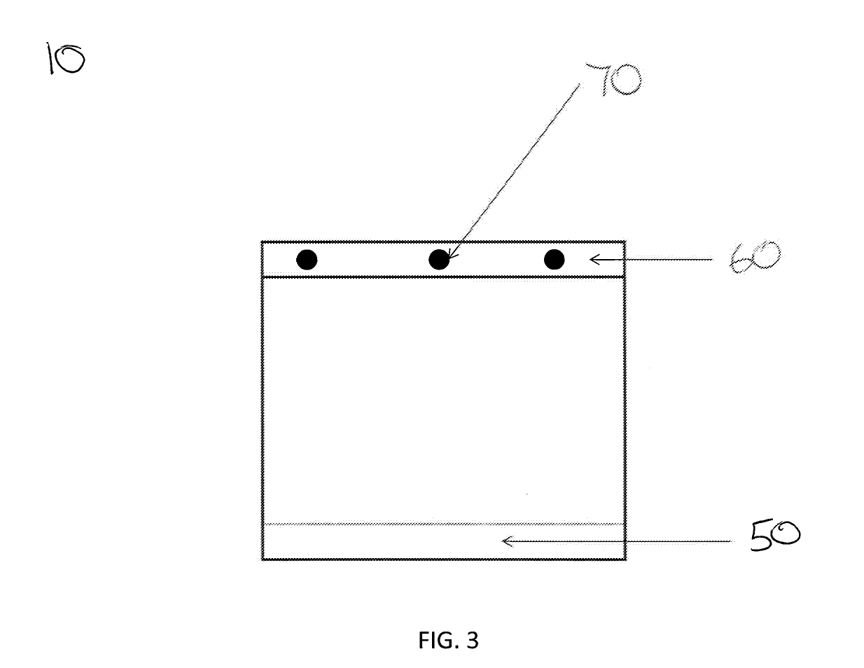

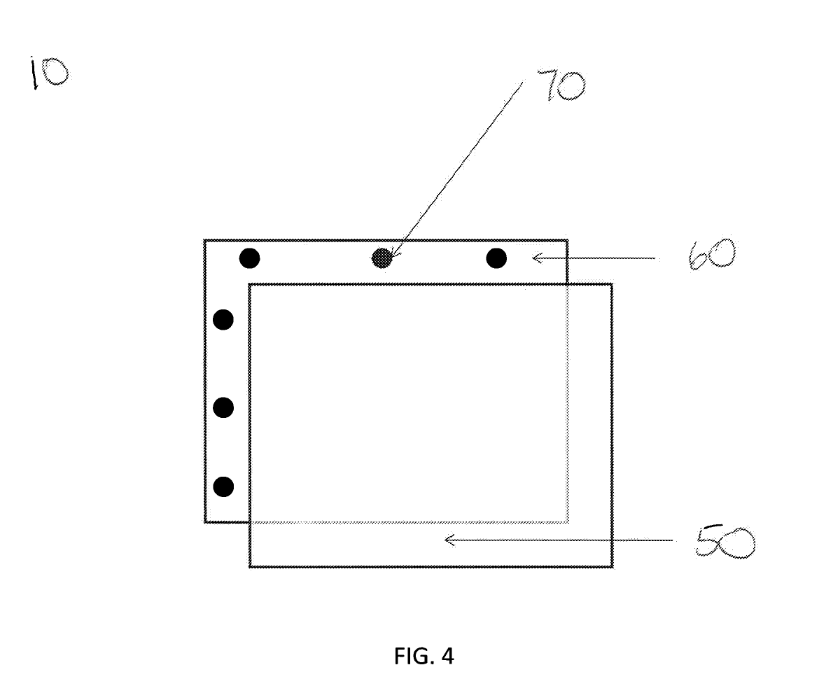

In another embodiment, the laminate composite material 10 products for end use may include structural laps to improve performance and simplify installation as illustrated in FIG. 3. FIG. 3 illustrates a laminate composite material sheet 10 having an MgO lap 50 and a building material lap 60. The MgO lap 50 is more weather resistant and helps to protect the building material lap 60 of the previous layer. The MgO lap 50 also hides and protects the fasteners which may be applied only on the building material lap 60. FIG. 4 illustrates a construction unit of siding, roof tiles, or shingles with double laps. The double lap design allows the use of additional hidden fasteners and improve performance.

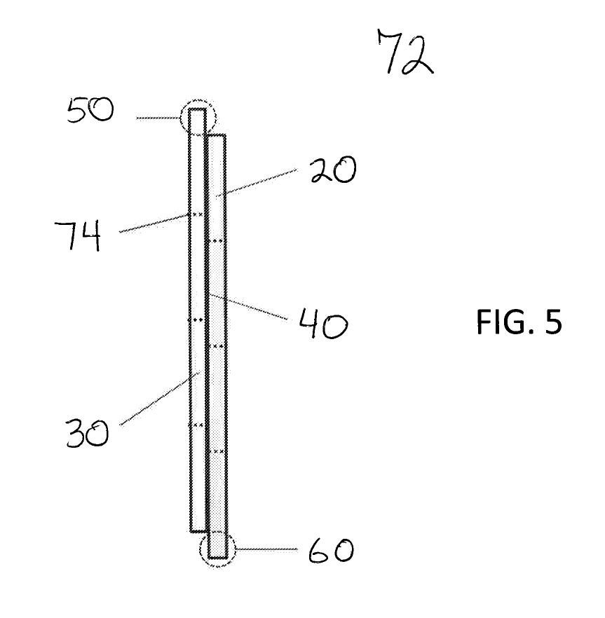

FIG. 5 illustrates the adhesive application pattern 72 and cutting lines 74 for lap styled laminated products. The adhesives 40 are applied in a pattern so that when the MgO layer 30 and the building material substrate layer 20 are cut separately at the appropriate positions 74, the large sheet 72 will separate into multiple sheets 10 having an MgO lap 50 and a building material lap 60.

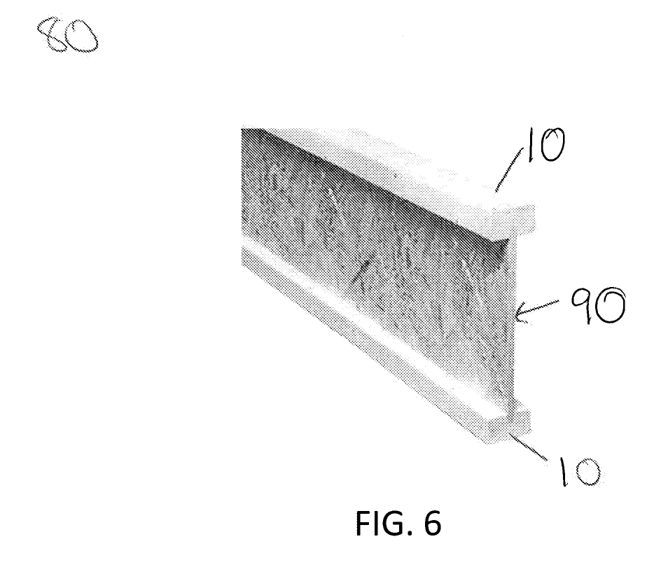

In yet another embodiment, MgO boards 30 may also be laminated to engineered wood products such as I-joists. FIG. 6 illustrates an I-joist 80, which typically is comprised of a web 90 and two flanges 100. In such products, the flange 100 is treated with conventional fire retardants or fire retardant coatings and the web 90 is laminated with MgO boards 30. The flange 100 material is normally made from solid wood or laminated veneer lumber and can be treated easily with conventional fire retardant. The web 90, however, cannot be easily treated with conventional water based fire retardants, and is the most vulnerable part of the assembly in case of fire. Combining a flange 100 treated with conventional fire retardant with an untreated web 90—with MgO boards 30 on both sides of the web 90—provides a good solution to the I-joist vulnerability problem.

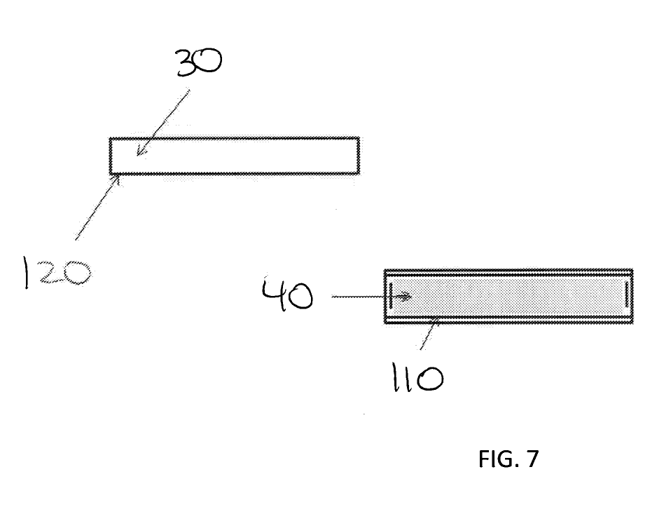

As shown by FIG. 7, the MgO board 30 should be dimensioned to be slightly smaller than the building material web 90 to allow for dimensional changes of the web 90 and to prevent resultant damage to the MgO board 30 that may result from I-joist deflection. For assembly of composite I-joists 80, an adhesive 40 is applied to the center area of the building material 90. Next, a bead of flexible fire retardant caulking 110 is applied to the edges of the building material 90, the MgO board 30, or both. The MgO board 30 and building material 90 are then pressed together. When pressing them together, the fire retardant caulking 100 spreads to seal the gaps 120 between the MgO board 30 and the flanges 100. The spreading of the caulk should prevent any damage to the MgO board 30 due to dimensional changes. This process should be performed on both sides of the web 90.

The MgO board 30 may also be laminated to the building material web 90 prior to the assembly of the web 90 and flanges 100 of the I-joist 80. In such cases, the fire retardant caulking 100 may be applied before or after I-joist 80 assembly using an automated applicator.

In the foregoing, a flame resistant laminate composition 10 and method of manufacturing the same has been described. Although the present invention has been described with reference to specific exemplary embodiments, it will be evident to one of ordinary skill in the art that various modifications and changes may be made to these embodiments without departing from the broader spirit and scope of the invention as set forth in the claims.

Accordingly, the specification and drawings are to be regarded in an illustrative rather than a restrictive sense.

What is claimed is:

1. A flame resistant building product prepared by a process comprising the steps of:
a. providing a prefabricated building material and a prefabricated cementitious material;
b. operatively connecting the prefabricated building material with the prefabricating cementitious material to create a flame resistant building product having a flame spread index less than 25.

2. A flame resistant and flexible I-joist product prepared by a process comprising the steps of:
a. providing a prefabricated I-joist having flanges treated with a fire retardant and an untreated web;
b. laminating one or both sides of an unassembled I-joist web having a fixed height with a cementitious material having a smaller height dimension such that a web lip is created at the top and bottom of the web; and
c. sealing the web lips with a fire retardant caulking.

3. A lapped flame resistant building product prepared by a process comprising the steps of:
a. providing a prefabricated building material and a prefabricated cementitious material;
b. positioning the prefabricated building material and prefabricated cementitious material to create single or double laps;
c. operatively connecting the prefabricated building material with the prefabricating cementitious material to create a flame resistant building product having a flame spread index less than 25.

4. The product of claim 1, 2, or 3, wherein the prefabricated cementitious material and prefabricated building material are operatively connected with a cementitious material adhesive cured under pressure between the building material and the cementitious material.

5. The product of claim 1, 2, or 3, wherein the prefabricated cementitious material and prefabricated building material are operatively connected with a cementitious material adhesive which is the same material as the prefabricated cementitious material.

6. The product of claim 5, wherein the prefabricated building material is plywood, fiber board, or oriented strand board.

7. The product of claim 5, wherein the prefabricated building material is treated with a preservative, fire retardant, water repellent, insecticide, moldicide, or any combination thereof.

8. The product of claim 5, wherein the prefabricated cementitious material contains property enhancing additives and/or colorants.
